(19) United States
(12) Patent Application Publication
(10) Pub. No.: US 2008/0002993 A1
(43) Pub. Date: Jan. 3, 2008

(54) Optical receiver with dual photodetector for common mode noise suppression

(76) Inventors: Peter E. Kirkpatrick, San Francisco, CA (US); Jan P. Peeters Weem, Hillsboro, OR (US)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/480,600

(22) Filed: Jun. 30, 2006

(51) Int. Cl. H04B 10/06

(52) U.S. Cl. 398/202

(57) ABSTRACT

An optical receiver has a photoelectric converter to receive an incoming optical communications signal. A circuit element that has similar electrical properties as the converter and is positioned in proximity to the converter is also provided. A differential amplifier has a pair of inputs that are coupled to respective electrical outputs of the converter and the circuit element. Other embodiments are also described and claimed.

An embodiment of the invention is directed to suppressing common mode noise in an optical receiver, and more particularly, using dual photodetectors. Other embodiments are also described.

### BACKGROUND

Light waveguide data communications (also referred to here as optical data communications) is becoming increasingly popular due to its advantages in relation to systems that use conductive wires for transmission. Such advantages include resistance against radio frequency interference and higher data rates. An example of a light waveguide transmission system is an optical fiber cable link. Such links are widely used for high speed communications between computer systems. Each system that is attached to the link has a transmitter portion and a receiver portion. The transmitter portion includes electronic circuitry that controls a light source such as a laser, to generate a light signal in the cable that is modulated with information and/or data to be transmitted. The light signal is detected at the receiver portion by a light detector, such as a photodiode, and with the help of appropriate circuitry the received data is then demodulated and recovered.

In a typical optical receiver, the light detector or photoelectric converter is optically coupled to receive an incoming optical communication signal off of the waveguide, where this signal was launched by a transmitter coupled to another end of the waveguide. The detector typically generates a single-ended, electrical output signal, and more commonly for the case of a photodiode, a current signal, that represents the received light signal. This is a relatively high speed (high frequency) signal that is then fed to a transimpedance amplifier (TIA). The TIA converts the current signal into a voltage signal that is also typically single-ended. Thereafter, the voltage signal is further processed to, for example, extract clock or data information that had been encoded into the signal by a transmitter device.

Signal processing is typically performed over a differential signal path to obtain better immunity against electromagnetic or radio frequency (RF) interference. Such RF interference causes what is termed “common mode noise”, that is, either conducted or radiated noise voltage that appears equally on each signal conductor relative to a common reference plane (e.g., ground). Operating a clock and data recovery circuit in differential mode means that many of its operations are performed differentially, thereby canceling to a large degree the common mode noise.

### BRIEF DESCRIPTION OF THE DRAWINGS

The embodiments of the invention are illustrated by way of example and not by way of limitation in the figures of the accompanying drawings in which like references indicate similar elements. It should be noted that references to “an” or “one” embodiment of the invention in this disclosure are not necessarily to the same embodiment, and they mean at least one.

FIG. 1 shows a circuit diagram of an optical receiver with common mode suppression capability, in accordance with an embodiment of the invention.

FIG. 2 is a circuit diagram of another embodiment of the optical receiver.

FIG. 3 is a conceptual diagram of a data processing system that has an optical I/O interconnect.

FIG. 4 is a diagram of a computer system with an optical back plane bus.

FIG. 5 is a block diagram of a data routing device that includes an optical receiver for optical links.

### DETAILED DESCRIPTION

An embodiment of the invention is directed to an optical receiver that exhibits increased electromagnetic immunity and in particular, increased resistance to RF interference, such as that typically present as radiated electrical noise inside an electronic enclosure that contains the optical receiver.

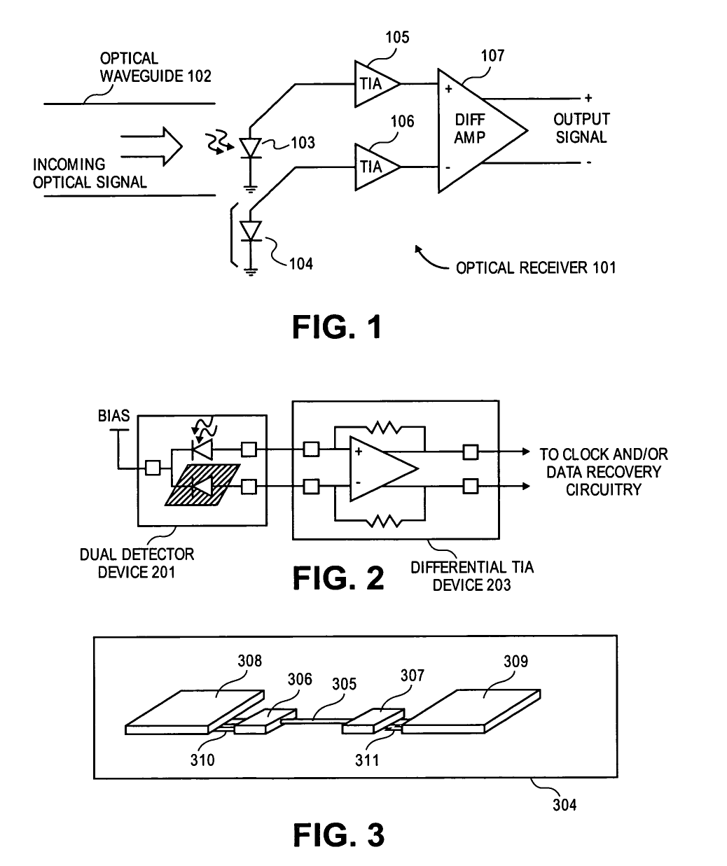

Beginning with FIG. 1, a circuit schematic of an optical receiver 101 is shown. A pair of photodiodes 103, 104 have their respective electrical outputs coupled to a pair of inputs (+ and −) of a differential amplifier 107. The first photodiode 103 is positioned to receive the radiation of an incoming optical communications signal from an optical waveguide 102, where the signal was launched by a transmitter at transmitting device (not shown) at another end of the waveguide 102. The second photodiode 104 is shielded from the incoming optical signal, but is otherwise a replicate of the first photodiode 103. The coupling between the photodiodes and the differential amplifier is via separate transimpedance amplifiers (TIAs) 105, 106, respectively. Each TIA serves to convert a current signal from its photodiode into a voltage signal that is the input to the differential amplifier 107.

All of the components shown in FIG. 1 are positioned in close proximity to each other. In addition, the TIAs 105, 106 may be replicates and are coupled to the photodiodes and the differential amplifier in a similar manner. These factors help the entire circuitry capture the same ambient electrical noise that is in the optical receiver 101. In addition, this helps the photodiode 103 and TIA 105 to exhibit similar electrical properties as the photodiode 104 and TIA 106 (e.g., such as when both photodiodes are illuminated by the same optical signal). As a result, any common noise that has been picked up by the receiver circuitry between the photodiodes and the differential amplifier will be essentially eliminated, if not substantially reduced, in the output signal from the differential amplifier 107. As the second photodiode 104 is shielded from the incoming optical signal, the output signal represents the information in the output of the first photodiode 103, but with common mode noise suppressed. This output signal may then be fed to a conventional clock and/or data recovery circuit (not shown).

In the embodiment depicted in FIG. 1, the optical receiver 101 has a pair of transimpedance amplifiers (TIAs) 105, 106, each having an input coupled to the respective electrical output of the photodiode 103, 104. An output of each TIA is coupled to a respective one of the inverting and non-inverting inputs of the differential amplifier 107. The input to each TIA is a current signal, whereas its output is a voltage signal that may be applied to a high impedance input stage of an operational amplifier. The TIA 105, 106 may be a linear TIA that exhibits increased dynamic range, for improved performance with certain types of intensity modulated incoming optical signals.

Turning now to FIG. 2, another embodiment of the invention is shown in which the two photodiodes are coupled to each other in a common cathode configuration, as a monolithic circuit (dual detector device 210). Note that one of the photodiodes is depicted as being shielded relative to the other, from the incoming optical signal. A suitable bias signal is applied to the common cathode, and the outputs of the photodiodes are at their respective anodes. These are wired to the inverting and non-inverting inputs of a differential TIA device 203. The differential TIA device 203 incorporates the functionality of both the differential amplifier 107 and the TIAs 105, 106 (see FIG. 1) into a single, monolithic circuit. As with the embodiment of FIG. 1, the output of the differential TIA device 203 may be fed to clock and/or data recovery circuitry (not shown) of the receiving device at the receiving end of the optical link. Note that in the dual detector device 201, because the two photodiodes are very close in proximity and built on the same substrate, they will be subject to the same coupled noise and interference, and thus should have the same noise characteristics. This enhances the cancellation of the common noise, as reflected in the output of the differential TIA device 203. The optical receiver is thus more immune to noise then a standard optical receiver.

Turning now to FIG. 3, a conceptual diagram of a data processing system that incorporates an optical receiver in accordance with the various embodiments of the invention is shown. The system may be a personal computer (PC) unit, a server unit, a packet communications switch, or other system that uses an optical I/O interconnect for its constituent devices or elements to communicate with each other. The system has an electronic equipment enclosure 304, e.g. a package, a chassis, in which several items are installed. These include an optical I/O interconnect or optical link that is comprised of, in this embodiment, a fiber optic line 305 that makes a point-to-point connection between a first transceiver 306 and a second transceiver 307. In this case, each of the transceivers 306, 307 is a discrete unit that is electrically coupled to its respective data processing element 308, 309 by high speed electrical communication links 310, 311. The transceiver 306 has an optical receiver, in accordance with any of the embodiments described above, that is coupled to receive an incoming optical communications signal over the line 305 and that was transmitted by the transceiver 307. The line 305 may be operated bi-directionally or there may be an additional line (not shown), to allow two-way communications between the transceivers. More generally, FIG. 3 may also refer to interconnects that comprise a parallel optical link where there are multiple instances of the optical receivers described above that are operating in parallel to implement two or more channels of the interconnect, where each channel may have its separate optical fiber line (and associated incoming optical signal).

The clock and/or data recovery circuitry that was mentioned above may be incorporated in either the transceiver 306, 307 or in some cases in the respective data processing element 308, 309. Examples of the data processing elements include a central processing unit (CPU), main memory subsystem (e.g., comprised of random access memory, and in particular dynamic random access memory), a graphics controller hub, an I/O controller hub, and a root complex. Note that there may be additional sets of waveguides and transceivers (optical links) in the system 304, that communicatively couple the data processing elements 308, 309 to other data processing elements (not shown).

It was mentioned above that the transceivers 306, 307 are in this case discrete devices, that is separate from their respective data processing elements 308, 309. In that case, the elements 308, 309 would be manufactured as part of different integrated circuit dies. As an alternative, all of the elements, including the transceivers 306, 307 and the data processing elements 308, 309, may be integrated into the same IC package, or as monolithic circuits on the same substrate. Thus, the diagram in FIG. 3 is intended to represent the waveguide 305 as part of both an optical chip-to-chip interconnect, as well as alternatively an optical on-chip interconnect (that is part of the system 304).

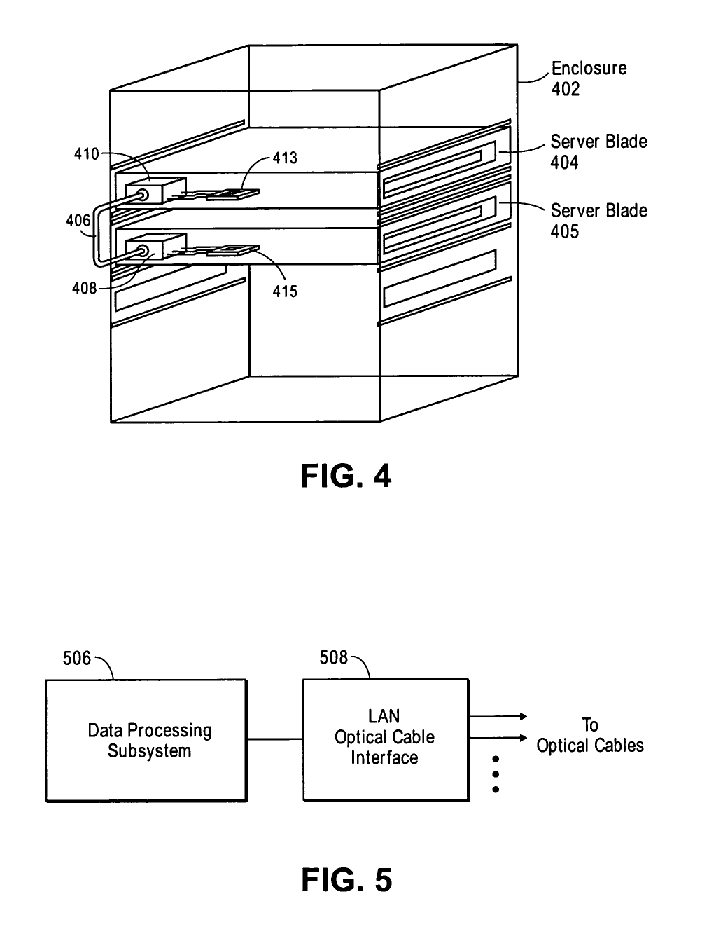

Referring now to FIG. 4, a conceptual diagram of a computer system that uses optical data communications is shown. This is one example of a system application of the optical receiver described above. The computer system has an enclosure 402 (e.g., a computing or telecommunications rack or chassis) in which a number of server blades 404 can be inserted. The server blades 404, 405 can communicate with each other, as nodes of a local area network, for example, over an optical point-to-point data bus 406. The bus 406 may be part of an optical back plane link and may include an optical fiber cable whose ends are communicatively coupled to optical transceiver modules 408, 410 that are part of their respective server blades 404, 405. Each server blade 404, 405 also has a data processing element 413, 415 that is coupled to the optical bus 406 by its respective transceiver module 410, 408. The data processing element 413, 415 may be an I/O hub integrated circuit, which may be integrated with a central processing unit (CPU) of the server blade, or may be connected to the CPU externally. The data processing element 413, 415 has a bus interface that sends and receives one or more bit streams to and from its respective transceiver module 410, 408. The transceiver module 410, 408 may include an optical receiver as described above in connection with FIGS. 1-2, to implement optical communications between the server blades.

FIG. 5 shows another system application of the optical receiver described above, in the form of a data routing device. The data routing device may be a switch or a router that can process and forward data packets. As an alternative, the device may be one that passes time division multiplexed (TDM) signals. The data routing device has a data processing subsystem 506 that may have a CPU and memory that are programmed to process data traffic that is routed by the device. Incoming and outgoing data traffic are via optical cables (not shown) that are connected to a local area network (LAN) optical cable interface 508 of the routing device. The interface 508 is designed for LAN optical cables which are used in short distance optical links, in contrast to long distance or long-haul optical cables such as those typically used by telecommunication companies and long-haul fiber optic networks. In addition to the optical receiver circuitry described above, the interface 508 may also include an integrated, LAN optical cable connector (that mates with one attached to the optical cable), and serializer-deserializer circuitry that serializes packets from the data processing subsystem 506 for transmission, and deserializes a received bit stream from the optical cables into, for example, multiple byte words in the format of the data processing subsystem 506. The data processing subsystem 506 operates on such packets to determine, for example, a destination node to which the packet will be forwarded, using a routing algorithm, for example, and/or a routing table.

The optical receiver described here may be used in a variety of optical links, including dense, parallel links, as well as single channel, short reach links where the receiver's sensitivity worsens noticeably as the transceiver is powered on. Other system applications of the optical receiver include usage in an interface to a long distance or long-haul optical cable link, such as those typically used by telecommunication companies and long-haul fiber optic networks.

The invention is not limited to the specific embodiments described above. For example, although the different embodiments refer to photodiodes, other types of photoelectric converters may alternatively be used. In addition, it is also contemplated that the second photodiode 104 may be replaced with a circuit element that is not, strictly speaking, a photoelectric converter but rather a circuit element that has similar electrical properties as the converter which is actually used to detect the incoming optical signal. Accordingly, other embodiments are within the scope of the claims.

What is claimed is:

1. An optical receiver comprising:
a photoelectric converter to receive an incoming optical communications signal;
a circuit element having similar electrical properties as the converter; and
a differential amplifier having a pair of inputs coupled to respective electrical outputs of the converter and the circuit element.

2. The optical receiver of claim 1 further comprising:
a first transimpedance amplifier (TIA) having an input coupled to the respective electrical output of the converter, and an output coupled to one of the inputs of the differential amplifier; and
a second TIA having an input coupled to the respective electrical output of the circuit element, and an output coupled to another one of the inputs of the differential amplifier.

3. The optical receiver of claim 2 wherein the converter comprises a photodiode, and the circuit element comprises another photodiode.

4. The optical receiver of claim 3 wherein said another photodiode is shielded from the incoming optical communications signal.

5. The optical receiver of claim 4 wherein the photodiode and said another photodiode are coupled to each other in common cathode configuration as a monolithic circuit, and anodes of the photodiode and said another photodiode are coupled to the pair of inputs of the differential amplifier, respectively.

6. The optical receiver of claim 5 wherein the differential amplifier is a transimpedance amplifier.

7. A data processing system comprising:
an electronic equipment enclosure;
an optical I/O interconnect within the enclosure; and
first and second data processing elements installed in the enclosure and communicatively coupled to each other via the interconnect, the interconnect having a plurality of optical receivers to operate in parallel, each receiver having a first photodiode to receive an incoming optical communications signal of the interconnect, a second photodiode on chip with the first photodiode but shielded from the incoming optical communications signal, and a differential amplifier having a pair of inputs coupled to respective electrical outputs of the first and second photodiodes.

8. The data processing system of claim 7 wherein the interconnect comprises a parallel optical link in which the first photodiode of each receiver is to receive a separate, incoming optical signal of the interconnect.

9. The data processing system of claim 7 wherein the first and second data processing elements are in different integrated circuit dies.

10. The data processing system of claim 7 wherein the receiver further comprises:
a first transimpedance amplifier (TIA) having an input coupled to the respective electrical output of the first photodiode, and an output coupled to one of the inputs of the differential amplifier; and
a second TIA having an input coupled to the respective electrical output of the second photodiode, and an output coupled to another one of the inputs of the differential amplifier.

11. The data processing system of claim 7 wherein the first and second photodiodes are coupled to each other in common cathode configuration as a monolithic circuit, and anodes of the photodiodes are coupled to the pair of inputs of the differential amplifier, respectively.

12. The data processing system of claim 11 wherein the differential amplifier is also a transimpedance amplifier.

13. A data processing system comprising:
an electronic equipment enclosure;
an optical back plane bus within the enclosure; and
first and second data processing elements installed in the enclosure and communicatively coupled to each other via the bus, the interconnect having an optical receiver that has a first photodiode to receive an incoming optical communications signal of the bus, a second photodiode on chip with the first photodiode but shielded from the incoming optical communications signal, and a differential amplifier having a pair of inputs coupled to respective electrical outputs of the first and second photodiodes.

14. The data processing system of claim 13 wherein the first and second data processing elements are in different server blades that coupled to the bus.

15. The data processing system of claim 13 wherein the receiver further comprises:
a first transimpedance amplifier (TIA) having an input coupled to the respective electrical output of the first photodiode, and an output coupled to one of the inputs of the differential amplifier; and
a second TIA having an input coupled to the respective electrical output of the second photodiode, and an output coupled to another one of the inputs of the differential amplifier.

16. The data processing system of claim 13 wherein the first and second photodiodes are coupled to each other in common cathode configuration as a monolithic circuit, and anodes of the photodiodes are coupled to the pair of inputs of the differential amplifier, respectively.

17. The data processing system of claim 15 wherein the differential amplifier is a transimpedance amplifier.
